(19) United States
(12) Patent Application Publication
(10) Pub. No.: US 2026/0304581 A1
(43) Pub. Date: Oct. 1, 2026

(54) ELECTROHYDRAULIC DYNAMIC SHIFT ARC EXTINGUISHING STRUCTURE, ARC EXTINGUISHING METHOD, AND APPLICATION

(71) Applicant: NANNING CHAOFU ELECTRICAL TECHNOLOGY CO., LTD., NANNING CITY (CN)

(72) Inventor: YANLEI WANG, NANNING CITY (CN)

(21) Appl. No.: 19/327,939

(22) Filed: Sep. 12, 2025

(30) Foreign Application Priority Data
Mar. 27, 2025 (CN) 202510375839.1

(51) Int. Cl. H05F 3/00

(52) U.S. Cl. CPC H05F 3/00

(57) ABSTRACT

Provided are an electrohydraulic dynamic shift arc extinguishing structure, an arc extinguishing method and application. The dynamic shift arc extinguishing structure includes an insulating enclosure, an air terminal, a lower electrode plate, and a free telescoping shift assembly vertically arranged in a cavity of insulating enclosure. The air terminal is vertically arranged at a top end of the insulating enclosure, and a lower end of the air terminal extends downward into the insulating enclosure and is electrically connected to an upper end of the free telescoping shift assembly. The lower electrode plate is horizontally arranged in a bottom end of the insulating enclosure, a screw is vertically arranged at the bottom end of the insulating enclosure, an upper end of the screw vertically extends upward into a bottom end in the cavity of the insulating enclosure and is connected to a lower surface of the lower electrode plate.

### CROSS-REFERENCE TO RELATED APPLICATION

This patent application claims the benefit and priority of Chinese Patent Application No. 202510375839.1, filed with the China National Intellectual Property Administration on Mar. 27, 2025, the disclosure of which is incorporated by reference herein in its entirety as part of the present application.

### TECHNICAL FIELD

The present disclosure relates to the technical field of lightning protection, and in particular to an electrohydraulic dynamic shift arc extinguishing structure, an arc extinguishing method, and application.

### BACKGROUND

As a novel lightning protection and arc extinguishing technology, an electrohydraulic arc extinguishing technology has been gradually applied to all levels of transmission lines by means of its advantages of fast arc extinguishing speed, strong arc extinguishing ability and high arc extinguishing success rate, and has played a significant protective role. In general, an arc extinguishing device with the electrohydraulic effect needs to be internally provided with one or more insulating liquid gaps with a fixed length to provide a liquid channel for current discharge, thereby triggering the electrohydraulic effect for forced arc extinguishing. However, the fixed liquid gap may lead to the increase of an initial breakdown voltage of the arc extinguishing device, which is not conducive to insulation cooperation. In addition, the fixed liquid gap limits a length of a discharge arc in the insulating liquid, making it impossible to release the arc energy to the maximum extent for arc extinguishing. Therefore, a novel electrohydraulic arc extinguishing structure with a low initial breakdown voltage and capable of dynamically elongating an arc and a method thereof are urgently needed.

### SUMMARY

An objective of the present disclosure is to provide an electrohydraulic dynamic shift arc extinguishing structure, an arc extinguishing method, and application. The arc extinguishing structure provided by the present disclosure can reduce an initial breakdown voltage and elongate an arc length, thereby improving arc extinguishing ability. To achieve the objective, the present disclosure employs the technical solution as follows.

According to one aspect of the present disclosure, an electrohydraulic dynamic shift arc extinguishing structure is provided. The shift arc extinguishing structure includes an insulating enclosure, an air terminal, a lower electrode plate, and a free telescoping shift assembly vertically arranged in a cavity of the insulating enclosure, where the cavity of the insulating enclosure is filled with an insulating liquid.

The air terminal is vertically arranged at a top end of the insulating enclosure, a lower end of the air terminal extends downward into the insulating enclosure and is electrically connected to an upper end of the free telescoping shift assembly. The lower electrode plate is horizontally arranged in a bottom end of the insulating enclosure, a screw is vertically arranged at the bottom end of the insulating enclosure, and an upper end of the screw vertically extends upward into a bottom end in the cavity of the insulating enclosure and is connected to a lower surface of the lower electrode plate. A lower end of the free telescoping shift assembly vertically extends downward to a position above the lower electrode plate and is in contact with an upper surface of the lower electrode plate, or separated from the upper surface of the lower electrode plate by a gap.

An earthing electrode is vertically and fixedly arranged on the upper surface of the lower electrode plate, a displacement electrode is arranged at the lower end of the free telescoping shift assembly, and a lower end of the displacement electrode at the lower end of the free telescoping shift assembly is in contact with a tip of the earthing electrode, or separated from the tip of the earthing electrode by a gap.

The foregoing solution is further preferred that a shift electrode plate is horizontally arranged at a lower end of the displacement electrode, and the center of a surface of the shift electrode plate is in contact with the tip of the earthing electrode, or separated from the tip of the earthing electrode by a gap.

The foregoing solution is further preferred that an upper electrode plate is horizontally and fixedly arranged on an inner top end of the cavity of the insulating enclosure, the lower end of the air terminal extends downward into the insulating enclosure and is fixedly connected to an upper surface of the upper electrode plate, and a lower surface of the upper electrode plate is electrically connected to the upper end of the free telescoping shift assembly.

The foregoing solution is further preferred that a section of positioning cavity in communication with the air terminal and the cavity of the insulating enclosure is arranged between the lower end of the air terminal and the inner top end of the cavity of the insulating enclosure, and a diameter of the positioning cavity is smaller than that of the cavity of the insulating enclosure. The upper electrode plate is horizontally and fixedly arranged at a top end of the positioning cavity, and the lower end of the air terminal extends downward into the top end of the positioning cavity and is connected to the center of the upper surface of the upper electrode plate. The upper end of the free telescoping shift assembly is partially arranged in the positioning cavity, and the upper end of the free telescoping shift assembly is connected to a lower surface of a partition electrode plate.

The foregoing solution is further preferred that a partition electrode plate is horizontally and fixedly arranged in the positioning cavity above the inner top end of the cavity of the insulating enclosure, and multiple layers of discharge electrode plates which are uniformly stacked are arranged in the positioning cavity between the partition electrode plate and the upper electrode plate, and the upper end of the free telescoping shift assembly extends into the positioning cavity and is connected to a lower surface of the partition electrode plate. A lower end of the free telescoping shift assembly vertically extends downward to a position above the lower electrode plate and is in contact with an upper surface of the lower electrode plate, or separated from the upper surface of the lower electrode plate by a gap.

The foregoing solution is further preferred that a uniform electric field air gap is disposed between adjacent layers of discharge electrode plates, the electric field air gap has a height of 0.1 mm to 1 mm, and the discharge electrode plate is a graphite sheet or a metal oxide electrode plate.

The foregoing solution is further preferred that the free telescoping shift assembly is a temperature-sensitive spring, and an insulating skirt is disposed on an outer wall of the insulating enclosure.

According to another aspect of the present disclosure, the present disclosure provides an arc extinguishing method of an electrohydraulic dynamic shift arc extinguishing structure, including the following steps:
before lightning interception, establishing an electric arc extinguishing channel through an air terminal, an upper electrode plate, a free telescoping shift assembly, a lower electrode plate and a screw in a cavity of an insulating enclosure, where the free telescoping shift assembly is a temperature-sensitive spring;
during lightning interception, enabling an impulse voltage to break through an outer air gap above an air terminal, and an impulse current and a power frequency follow current to enter the electric arc extinguishing channel formed by the telescopic shift assembly composed of the temperature-sensitive spring in the insulating enclosure from the air terminal, where when the current passes through the free telescoping shift assembly, a temperature of the temperature-sensitive spring rises, and the impulse current and the power frequency follow current are discharged in an insulating liquid gap to form an initial short arc which is able to trigger an initial electrohydraulic effect and generate an initial electrohydraulic pressure, the initial electrohydraulic pressure drives the free telescoping shift assembly to contract at a high speed to move upwards, which makes an insulating liquid gap between a lower end of the free telescoping shift assembly and the lower electrode plate increase suddenly, thereby elongating a length of a discharge arc instantly, wherein a generated high-intensity electrohydraulic pressure acts on a surface of a long arc to form a full-scale arc break and forcibly extinguish the impulse current and a power frequency follow current.

According to the foregoing technical solution of the present disclosure, the present disclosure further provides the foregoing shift arc extinguishing structure applied to a surge suppressor, where the surge suppressor includes a shift arc extinguishing structure. The shift arc extinguishing structure includes an insulating enclosure, an air terminal, a lower electrode plate, and a free telescoping shift assembly vertically arranged in a cavity of insulating enclosure. The cavity of the insulating enclosure is filled with an insulating liquid, the air terminal is vertically arranged at a top end of the insulating enclosure, an upper electrode plate is horizontally and fixedly arranged at an inner top end of the cavity of the insulating enclosure, the lower electrode plate is horizontally arranged in a bottom end of the insulating enclosure, a screw is vertically arranged outside the bottom end of the insulating enclosure, an upper end of the screw vertically extends into a bottom end in the cavity of the insulating enclosure and is connected to a lower surface of the lower electrode plate, and a lower end of the free telescoping shift assembly vertically extends downward to a position above the lower electrode plate and is in contact with an upper surface of the lower electrode plate, or separated from the upper surface of the lower electrode plate by a gap. A partition electrode plate is horizontally and fixedly arranged in a positioning cavity above the inner top end of the cavity of the insulating enclosure, multiple layers of discharge electrode plates which are uniformly stacked are arranged in the positioning cavity between the partition electrode plate and the upper electrode plate, and an upper end of the free telescoping shift assembly extends into the positioning cavity and is connected to a lower surface of the partition electrode plate.

In conclusion, by employing the technical solution, the present disclosure has the following technical effects.
(1) When the arc extinguishing structure of the present disclosure is used for arc extinguishing, the arc releases a large amount of high heat energy in the liquid gap, and generates a dynamically superimposed high-strength liquid-electric effect pressure to act on an arc-building channel, which instantly interrupts an impulse arc and extinguishes a power frequency follow current, thereby accelerating a generation speed of an initial electrohydraulic pressure, advancing a time node of the electrohydraulic-based arc extinguishing, improving the instantaneity of the electrohydraulic effect, and enhancing forced arc extinguishing ability.
(2) An elongated liquid gap increases a reignition breakdown distance, and the electrohydraulic pressure increases a dielectric breakdown field strength, so that a threshold of a reignition breakdown voltage of the whole structure is improved, the reignition of the impulse arc is delayed, and the power frequency follow current cannot be reignited.
(3) The arc extinguishing structure of the present disclosure has the following characteristics: firstly, at a stage of lightning voltage breakdown arc extinguishing channel, an initial breakdown voltage generated by a space of an electrohydraulic arc-extinguishing chamber inside the insulating enclosure is reduced to zero by arranging a temperature-sensitive telescopic spring to short-circuit the liquid gap. The breakdown voltage of the arc-extinguishing channel is determined by a breakdown voltage of an air gap connected in series outside the arc-extinguishing chamber, thereby eliminating the influence of an excessively high breakdown voltage of the liquid gap on insulation cooperation. Secondly, in the process of arc extinguishing, the temperature-sensitive telescopic spring can contract quickly and become shorter under the action of spring temperature rise generated by the impulse current, thereby eliminating the short circuit of the liquid gap and dynamically elongate the length of the arc. By coupling the impulse arc and a power frequency arc with insulating oil and liquid, a dynamic electrohydraulic pressure is generated to forcibly extinguish the power frequency flow current and improve the arc extinguishing ability. Finally, the temperature-sensitive spring contracted to a limit state forms a largest liquid gap, which improves the breakdown voltage of the liquid gap. Meanwhile, a liquid density and a breakdown field strength are improved by sealing the electrohydraulic pressure maintained in the arc-extinguishing chamber after arc extinguishing, and the breakdown voltage is also improved. The improvement of the foregoing two breakdown voltages greatly improves the ability of the arc-extinguishing chamber to withstand arc reignition.

### BRIEF DESCRIPTION OF THE DRAWINGS

FIG. 1 is a structural diagram of a first embodiment of an electrohydraulic dynamic shift arc-extinguishing structure according to the present disclosure;

FIG. 2 is a structural diagram of an electrohydraulic dynamic shift arc-extinguishing structure according to the present disclosure;

FIG. 3 is a structural diagram of a third embodiment of an electrohydraulic dynamic shift arc-extinguishing structure according to the present disclosure;

FIG. 4 is a structural diagram of a fourth embodiment of an electrohydraulic dynamic shift arc-extinguishing structure according to the present disclosure;

FIG. 5 is a structural diagram of a fifth embodiment of an electrohydraulic dynamic shift arc-extinguishing structure according to the present disclosure.

In the drawings: 1—insulating enclosure; 2—air terminal; 3—upper electrode plate; 4—lower electrode plate; 5—screw; 6—free telescoping shift assembly; 7—insulating liquid; 8—positioning cavity; 9—partition electrode plate; 10—earthing electrode; 11—displacement electrode; 13—insulating skirt; 12—shift electrode plate; 14—discharge electrode plate; 120—electric field air gap.

### DETAILED DESCRIPTION OF THE EMBODIMENTS

To make the objectives, technical solutions and advantages of the present disclosure more clearly, the present disclosure is further described in detail below with reference to accompanying drawings and preferred embodiments. However, it should be noted that many details listed in the specification are only for readers to have a thorough understanding of one or more aspects of the present disclosure, and these aspects of the present disclosure can be implemented without these specific details.

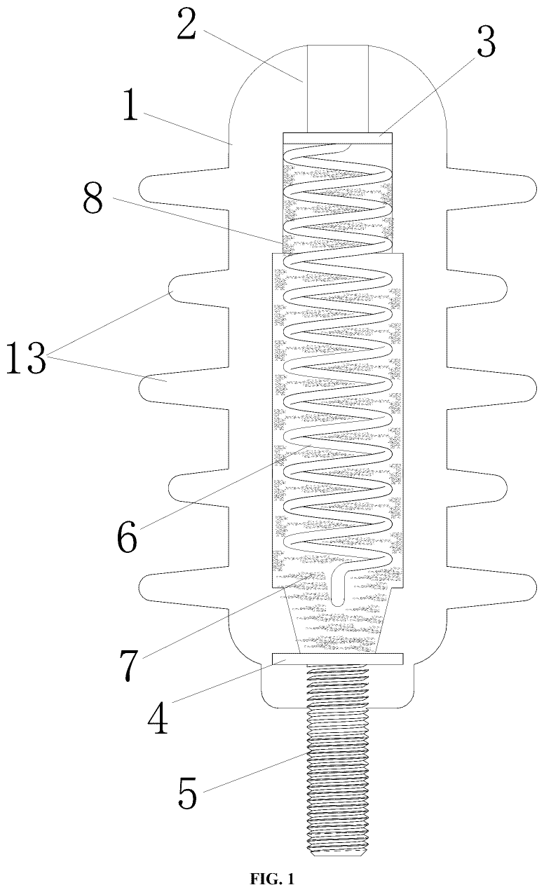

Embodiment 1: With reference to FIG. 1, an electrohydraulic dynamic shift arc-extinguishing structure according to the present disclosure is provided. The shift arc-extinguishing structure includes an insulating enclosure 1, an air terminal 2, a lower electrode plate 4, and a free telescoping shift assembly 6 vertically arranged in a cavity of the insulating enclosure 1. The cavity of the insulating enclosure 1 is filled with an insulating liquid 7, the air terminal 2 is vertically arranged at a top end of the insulating enclosure 1, a lower end of the air terminal 2 extends downward into the insulating enclosure 1 and is electrically connected to an upper end of the free telescoping shift assembly 6. The lower electrode plate 4 is horizontally arranged in a bottom end of the insulating enclosure 1, a screw 5 is vertically arranged at the bottom end of the insulating enclosure 1, an upper end of the screw 5 vertically extends upward to the bottom end in the cavity of the insulating enclosure 1 and is connected to a lower surface of the lower electrode plate 4, and a lower end of the free telescoping shift assembly 6 vertically extends downward to a position above the lower electrode plate 4 and is in contact with an upper surface of the lower electrode plate 4, or separated from the upper surface of the lower electrode plate 4 by a gap. In the present disclosure, an upper electrode plate 3 is horizontally and fixedly arranged at an inner top end of the cavity of the insulating enclosure 1, a lower end of the air terminal 2 extends downward into the insulating enclosure 1 and is fixedly connected to an upper surface of the upper electrode plate 3, and a lower surface of the upper electrode plate 3 is electrically connected to the upper end of the free telescoping shift assembly 6. The free telescoping shift assembly 6 is a temperature-sensitive spring, and an outer wall of the insulating enclosure 1 is provided with an insulating skirt 13.

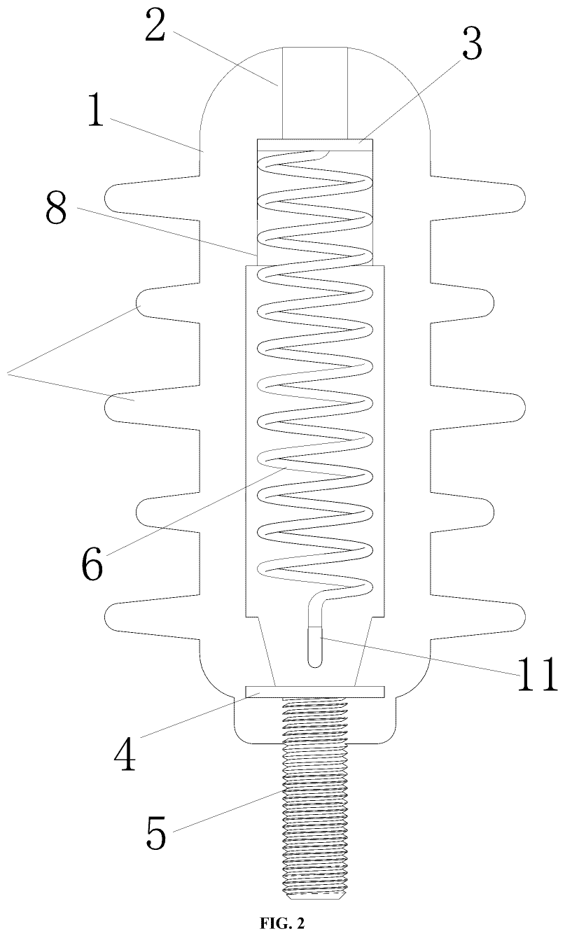

Embodiment 2: With reference to FIG. 1 and FIG. 2, a difference between this embodiment and Embodiment 1 is that a displacement electrode 11 is arranged at the lower end of the free telescoping shift assembly 6, and a lower end of the displacement electrode 11 at the lower end of the free telescoping shift assembly 6 is in contact with a surface of the lower electrode plate 4, or separated from the surface of the lower electrode plate 4 by a gap.

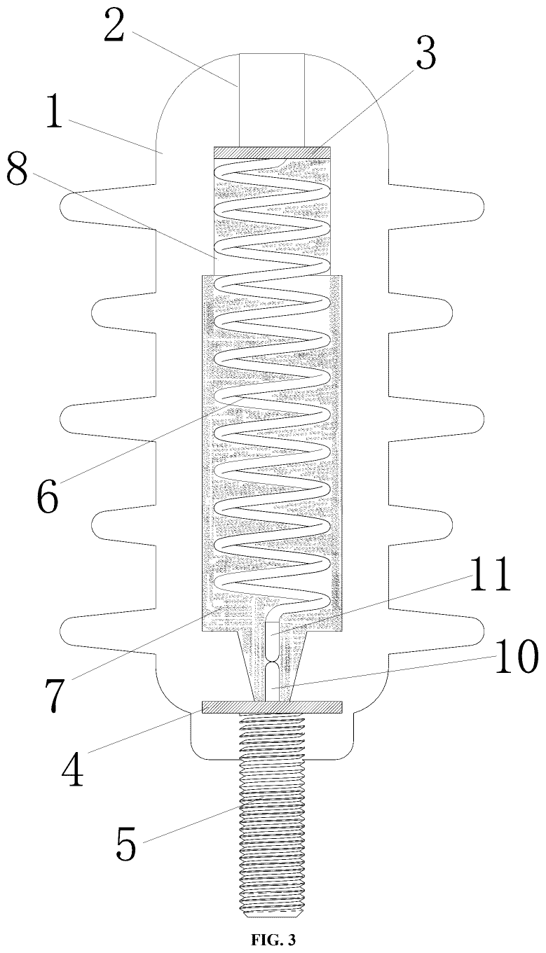

Embodiment 3: With reference to FIG. 3, a difference between this embodiment and Embodiment 2 is that an earthing electrode 10 is vertically and fixedly arranged on the upper surface of the lower electrode plate 4, the displacement electrode 11 is arranged at the lower end of the free telescoping shift assembly 6, and the lower end of the displacement electrode 11 at the lower end of the free telescoping shift assembly 6 is in contact with a tip of the earthing electrode 11, or separated from the tip of the earthing electrode 11 by a gap. The lower end of the displacement electrode 11 at the lower end of the free telescoping shift assembly 6 is in contact with a tip of the earthing electrode 10, or separated from the tip of the earthing electrode 10 by a gap. In this embodiment, the lower end of the displacement electrode 11 is in contact with the tip of the earthing electrode 10.

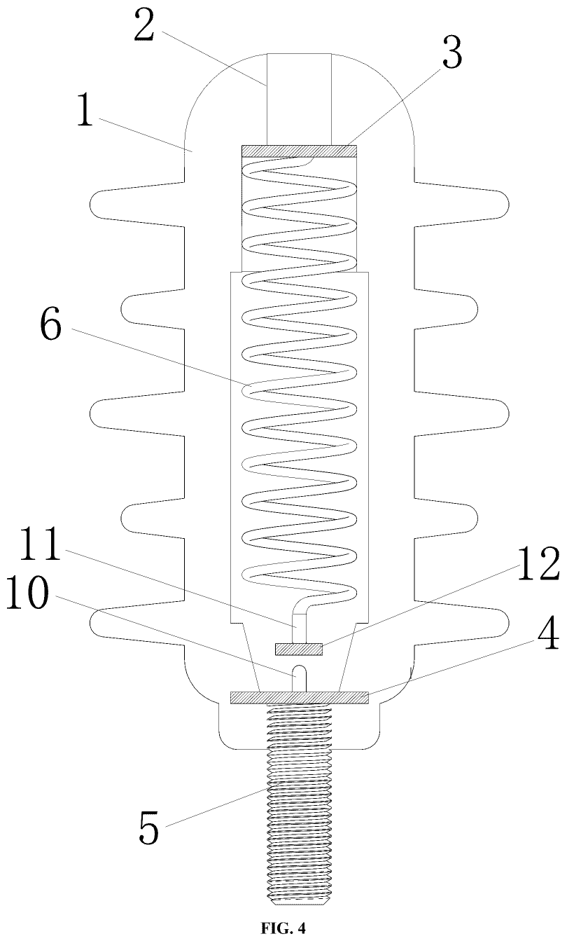

Embodiment 4: With reference to FIG. 4, a shift electrode plate 12 is horizontally arranged at the lower end of the displacement electrode 11, and the center of a surface of the shift electrode plate 12 is in contact with the tip of the earthing electrode 10, or separated from the tip of the earthing electrode 10 by a gap, so that a gap or contact discharge is formed between the shift electrode plate 12 at the lower end of the displacement electrode 11 and the earthing electrode 10 or the lower electrode plate 4.

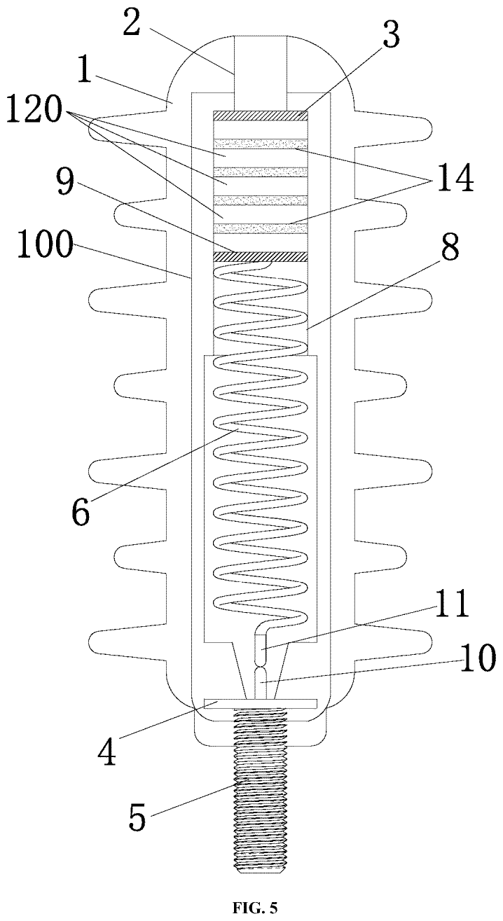

Embodiment 5: With reference to FIG. 5, a section of positioning cavity 8 in communication with the air terminal and the cavity of the insulating enclosure is arranged between the lower end of the air terminal 2 and the inner top end of the cavity of the insulating enclosure 1, and a diameter of the positioning cavity 8 is smaller than that of the cavity of the insulating enclosure 1. The upper electrode plate 3 is horizontally and fixedly arranged at a top end of the positioning cavity 8, and the lower end of the air terminal 2 extends downward into the top end of the positioning cavity 1 and is connected to the center of the upper surface of the upper electrode plate 3. The upper end of the free telescoping shift assembly 6 is partially arranged in the positioning cavity 8, and the upper end of the free telescoping shift assembly 6 is connected to a lower surface of a partition electrode plate 9. The partition electrode plate 9 is horizontally and fixedly arranged in the positioning cavity 8 above the inner top end of the cavity of the insulating enclosure 1, and multiple layers of uniformly stacked discharge electrode plates 14 are arranged in the positioning cavity 8 between the partition electrode plate 9 and the upper electrode plate 3, and the upper end of the free telescoping shift assembly 6 extends into the positioning cavity 8 and is connected to the lower surface of the partition electrode plate 9. There is a uniform electric field air gap 120 between adjacent layers of discharge electrode plates 14, and the electric field air gap 120 has a height of 0.1-1 mm. The discharge electrode plate 14 is a graphite sheet or a metal oxide electrode plate. The graphite sheet is preferably employed in the present disclosure. The free telescoping shift assembly 6 is a temperature-sensitive spring. The electric field air gaps 120 which are uniform and connected in series are formed between the discharge electrode plates 14 (graphite sheets 14), so that the electrohydraulic dynamic shift arc-extinguishing structure and the uniform electric field air gaps can form a series structure again. When an impulse current and a power frequency follow current pass through the free telescoping shift assembly, the temperature rise generated by the impulse current and the power frequency follow current enables the temperature-sensitive spring to contract to generate an initial arc electrohydraulic effect, the displacement electrode 11 at a lower end of the temperature-sensitive spring and the temperature-sensitive spring are driven to displace simultaneously to elongate the arc and generate a dynamic electrohydraulic pressure increased with the arc elongation, the electrohydraulic pressure acts on a full-scale arc surface to generate a full-scale arc break in the liquid gap and forcibly extinguish the power frequency follow-current arc. A dielectric breakdown field strength is improved from the full-scale long arc break and the electrohydraulic pressure, so that the breakdown voltage of the arc break is improved from two dimensions, and the arc reignition is strongly suppressed.

Embodiment 6: According to another aspect of the present disclosure, with reference to FIG. 1 to FIG. 5, the present disclosure further provides an arc extinguishing method of an electrohydraulic dynamic shift arc extinguishing structure, including the following steps.

Before lightning interception, an electric arc extinguishing channel is established through an air terminal 2, an upper electrode plate 3, a free telescoping shift assembly 6, a lower electrode plate 4 and a screw 5 in a cavity of an insulating enclosure 1, where the free telescoping shift assembly 6 is a temperature-sensitive spring.

During lightning interception, an impulse voltage breaks through an outer air gap above the air terminal 2, and an impulse current and a power frequency follow current enter the electric arc extinguishing channel formed by the telescopic shift assembly 6 composed of the temperature-sensitive spring in the insulating enclosure 1 from the air terminal 2, where when the current passes through the free telescoping shift assembly 6, a temperature of the temperature-sensitive spring rises, and the impulse current and the power frequency follow current are discharged in an insulating liquid gap to trigger an initial electrohydraulic effect, so that the free telescoping shift component 6 starts to contract to move upward, an initial insulating liquid gap is generated a lower end of the free telescoping shift assembly 6 and the lower electrode plate 4, the insulating liquid gap increases suddenly to elongate a length of the discharge arc instantly, a generated high-intensity electrohydraulic pressure acts on a surface the long arc to form a full-scale are break and forcibly extinguish the impulse current and the power frequency follow current. For a gap configuration structure, either the free telescoping shift assembly 6 (the temperature-sensitive spring) and the lower electrode plate 4 (or the earthing electrode 10), or the displacement electrode 11 on the free telescoping shift assembly 6 (the temperature-sensitive spring) and the lower electrode plate 4, are separated by a gap. During lightning protection, when the free telescoping shift assembly 6 (the temperature-sensitive spring) and the lower electrode plate are separated by a gap, the impulse voltage breaks through the outer air gas gap above the air terminal 2, the impulse current and the power frequency follow current discharge electricity in an initial insulating liquid gap via an initial insulating liquid gap among the air terminal 2, the free telescoping shift assembly 6 (the temperature-sensitive spring), the displacement electrode 11 and the lower electrode plate 4 (or the earthing electrode 10), thereby triggering an initial electrohydraulic effect and generating an initial electrohydraulic pressure.

For a contact configuration structure, the freely contractable shift assembly 6 (temperature-sensitive spring) is in contact with the lower electrode plate 4 (or the earthing electrode 10), or the displacement electrode 11 on the freely contractable shift assembly 6 (temperature-sensitive spring) is in contact with the lower electrode plate 4, an impulse current and a power frequency follow current are connected from the outer air gap above the air terminal 2, and enter an arc-extinguishing channel formed by the telescopic shift assembly 6 composed of the temperature-sensitive spring in the insulating enclosure 1 through the air terminal 2. When the impulse current and the power frequency follow current pass through the free telescoping shift assembly 6 (temperature-sensitive spring), the temperature of the free telescoping shift assembly 6 (temperature-sensitive spring) rises, and the free telescoping shift assembly 6 (temperature-sensitive spring) starts to contract and move up and drives the displacement electrode 11 to move up synchronously, so that an initial insulating liquid gap is generated between the displacement electrode 11 on the free telescoping shift assembly 6 (temperature-sensitive spring) and the lower electrode plate 4 (or the earthing electrode 10). The current discharges electricity in the initial insulating liquid gap to trigger an initial electrohydraulic effect and generate an initial electrohydraulic pressure. Under the self-contraction of the free telescoping shift assembly 6 (temperature-sensitive spring) and the driving action of the initial electrohydraulic pressure, the displacement electrode 11 is driven to move up quickly and dynamically elongate the arc, where a dynamic electrohydraulic pressure with continuously superimposed intensity is generated to act on the surface of the full-scale arc channel to form a full-scale arc break and forcibly extinguish the power frequency follow current.

The function of the electrohydraulic dynamic forced arc extinguishing chamber is to make the temperature-sensitive spring contract to generate an initial electrohydraulic effect through the temperature rise generated by the impulse current flowing through the temperature-sensitive spring, and the generated electrohydraulic pressure drives the displacement electrode 11 at the lower end of the temperature-sensitive spring to displace at the same time, thereby elongating the arc and generating the dynamic electrohydraulic pressure which increases with the arc elongation in the insulating enclosure 1, where the electrohydraulic pressure acts on the surface full-scale arc surface to generate full-scale arc break in a gap between the displacement electrode 11 and the earthing electrode 10 immersed in the insulating liquid 7 and forcibly extinguish the power frequency follow-current arc. A dielectric breakdown field strength is improved from the full-scale long arc break and the electrohydraulic pressure, so that the breakdown voltage of the arc break is improved from two dimensions, and the arc reignition is strongly suppressed.

To this end, because a static short-circuited gap contact resistance at the lower end of the free telescoping shift assembly 6 is high, the impulse current is able to generate a huge field strength on the gap contact resistance to break through the liquid to generate spark arc discharge, and an expansion force of the arc and the electrohydraulic pressure drive the displacement electrode to produce a jumping displacement, thereby achieving the following arc-extinguishing process.
(1) Due to the influence of a mechanism that the short-circuited gap activates the electrohydraulic effect, the displacement electrode is driven to move up quickly by the expansion force of the arc and the electrohydraulic pressure, and the large dynamic electrohydraulic pressure can meet the requirements of forced arc extinguishing at a higher voltage. Afterwards, the displacement electrode collides with the upper end of a pipe body, and quickly rebounds through a reaction force to restore a short-circuit state of the gap, thereby quickly restoring the insulation cooperation.
(2) Due to the influence of a mechanism that the short-circuited gap activates the electrohydraulic effect, the displacement electrode is jointly driven by the expansion force of the arc and the electrohydraulic pressure to move up quickly in a jumping manner. In an initial rise stage, the displacement electrode is fast in displacement speed due to a small temperature-sensitive damping force, which meets the requirements of forced arc extinguishing at a lower voltage. The subsequent rise of the displacement electrode will be reduced by the temperature-sensitive spring damping. A falling speed of the displacement electrode, due to the influence of an elastic force released by the spring, becomes faster, thereby rapidly restoring the insulation cooperation.
(3) Due to the influence of a mechanism that the short-circuited gap activates the electrohydraulic effect, the displacement electrode is jointly driven by the expansion force of the arc, the electrohydraulic pressure and an extension force of the temperature-sensitive spring. Firstly, an arc collision force firstly drives the displacement electrode to undergo jumping acceleration; secondly, the electrohydraulic pressure accelerates the displacement of the displacement electrode in a relay manner; and finally, a contraction force of the temperature-sensitive spring drives the displacement electrode to accelerate the upward displacement in a relay manner. Rapid cooling effect of a liquid with high specific heat capacity on the temperature-sensitive (thermosensitive) spring can make the spring reset quickly to short-circuit the gap again and restore the insulation cooperation requirements.

Embodiment 7: As shown in FIG. 5, when the electrohydraulic dynamic shift arc extinguishing structure is applied to a surge suppressor, the surge suppressor includes any shift arc extinguishing structure in Embodiment 1 to Embodiment 5, where the surge suppressor includes an insulating enclosure 1, an air terminal 2, a lower electrode plate 4, and a free telescoping shift assembly 6 vertically arranged in a cavity of insulating enclosure 1, where the cavity of the insulating enclosure 1 is filled with an insulating liquid 7. The air terminal 2 is vertically arranged at a top end of the insulating enclosure 1, an upper electrode plate 3 is horizontally and fixedly arranged at an inner top end of the cavity of the insulating enclosure 1, and the lower electrode plate 4 is horizontally arranged in the bottom end of the insulating enclosure 1. A screw 5 is vertically arranged outside the bottom end of the insulating enclosure 1, an upper end of the screw 5 vertically extends upward into a bottom end in the cavity of the insulating enclosure 1 and is connected to a lower surface of the lower electrode plate 4. A lower end of the free telescoping shift assembly 6 vertically extends downward to a position above the lower electrode plate 4 and is in contact with an upper surface of the lower electrode plate 4, or separated from the upper surface of the lower electrode plate 4 by a gap. A partition electrode plate 9 is horizontally and fixedly arranged in a positioning cavity 8 above the inner top end of the cavity of the insulating enclosure 1, and multiple layers of discharge electrode plates 14 which are uniformly stacked are arranged in the positioning cavity 8 between the partition electrode plate 9 and the upper electrode plate 3. An upper end of the free telescoping shift assembly 6 extends into the positioning cavity 8 and is connected to a lower surface of the partition electrode plate 9. There is a uniform electric field air gap 120 between adjacent layers of discharge electrode plates 14, and the electric field air gap 120 has a height of 0.1-1 mm. The discharge electrode plate 14 is a graphite sheet or a metal oxide electrode plate. In the present disclosure, the graphite is preferably employed, and the free telescoping shift assembly 6 is a temperature-sensitive spring.

Embodiment 8: With reference to FIG. 5, when the electrohydraulic dynamic shift arc extinguishing structure is applied to a surge suppressor, the surge suppressor includes any shift arc extinguishing structure in Embodiment 1 to Embodiment 5, where the surge suppressor includes an insulating enclosure 1, an air terminal 2, a lower electrode plate 4, and a free telescoping shift assembly 6 vertically arranged in a cavity of insulating enclosure 1, where the cavity of the insulating enclosure 1 is filled with an insulating liquid 7. The air terminal 2 is vertically arranged at a top end of the insulating enclosure 1, a lower end of the air terminal 2 extends downward into the insulating enclosure 1 and is electrically connected to an upper end of the free telescoping shift assembly 6. The lower electrode plate 4 is horizontally arranged in the bottom end of the insulating enclosure 1. A screw 5 is vertically arranged outside the bottom end of the insulating enclosure 1, an upper end of the screw 5 vertically extends upward into a bottom end in the cavity of the insulating enclosure 1 and is connected to a lower surface of the lower electrode plate 4. A lower end of the free telescoping shift assembly 6 vertically extends downward to a position above the lower electrode plate 4 and is in contact with an upper surface of the lower electrode plate 4, or separated from the upper surface of the lower electrode plate 4 by a gap. In the present disclosure, an upper electrode plate 3 is horizontally and fixedly arranged at an inner top end of the insulating enclosure 1, the lower end of the air terminal 2 extends downward into the insulating enclosure 1 and is fixedly connected to an upper surface of the upper electrode plate 3. A displacement electrode 11 is arranged at the lower end of the free telescoping shift assembly 6, an earthing electrode 10 is vertically and fixedly arranged on an upper surface of the lower electrode plate 4, and a lower end of the displacement electrode 11 is in contact with a tip of the earthing electrode 10, or separated from the tip of the earthing electrode 10 by a gap.

In the embodiment of the present disclosure, a section of positioning cavity 8 in communication with the air terminal and the cavity of the insulating enclosure is arranged between the lower end of the air terminal 2 and the inner top end of the cavity of the insulating enclosure 1, and a diameter of the positioning cavity 8 is smaller than that of the cavity of the insulating enclosure 1. The upper electrode plate 3 is horizontally and fixedly arranged at a top end of the positioning cavity 8, and the lower end of the air terminal 2 extends downward into the top end of the positioning cavity 1 and is connected to the center of the upper surface of the upper electrode plate 3. The upper end of the free telescoping shift assembly 6 is partially arranged in the positioning cavity 8, and the upper end of the free telescoping shift assembly 6 is connected to the lower surface of a partition electrode plate 9. A partition electrode plate 9 is horizontally and fixedly arranged in a positioning cavity 8 above the inner top end of the cavity of the insulating enclosure 1, and multiple layers of discharge electrode plates 14 which are uniformly stacked are arranged in the positioning cavity 8 between the partition electrode plate 9 and the upper electrode plate 3. The upper end of the free telescoping shift assembly 6 extends into the positioning cavity 8 and is connected to a lower surface of the partition electrode plate 9. There is a uniform electric field air gap 120 between adjacent layers of discharge electrode plates 14, and the electric field air gap 120 has a height of 0.1-1 mm. The discharge electrode plate 14 is a graphite sheet or a metal oxide electrode plate. In the present disclosure, the graphite is preferably employed, and the free telescoping shift assembly 6 is a temperature-sensitive spring. An outer wall of the insulating enclosure 1 is provided with, or not provided with, an insulating skirt. The electric field air gap 120 can control an impulse breakdown voltage to achieve insulation cooperation.

According to the embodiment of the present disclosure, a sealed protective housing 100 is arranged between a top end and a bottom end of the insulating enclosure 1, the lower end of the air terminal 2 extends into a top end of the sealed protective housing 100 to be connected to the upper electrode plate 3, and a lower end of the sealed protective housing 100 is fixed to a surface of the lower electrode plate 4. The upper electrode plate 3, the discharge electrode plate 14, the partition electrode plate 9, the free telescoping shift assembly 6, the displacement electrode 11 and the earthing electrode 10 form an arc extinguishing channel arranged in the sealed protective housing 100. During the use of the surge suppressor, electric field gas gaps 120 that are uniform and connected in aeries are formed between the discharge electrode plates 14 (graphite sheets), so that the electrohydraulic dynamically shift arc extinguishing structure and the uniform electric field gas gaps can form a series structure again. When an impulse current and a power frequency follow current flow through the free telescoping shift assembly, a temperature rise generated by the impulse current and the power frequency follow current makes the temperature-sensitive spring contract to generate an initial arc electrohydraulic effect, which drives the displacement electrode 11 at a lower end of the temperature-sensitive spring and the temperature-sensitive spring to displace simultaneously to elongate an arc and generate a dynamic electrohydraulic pressure increased with the elongation of the arc. The electrohydraulic pressure acts on a surface of a full-scale arc to generate a full-scale arc break in a liquid gap and forcibly extinguish a power frequency follow current arc. A dielectric breakthrough field strength is effectively improved from the full-scale arc break and the electrohydraulic pressure, thereby improving a breakdown voltage of the arc break from two dimensions, and achieving the function of strongly suppressing arc reignition. As an operating voltage of the surge suppressor is low, which is usually hundreds of volts to thousands of volts, an operating environment is an indoor or outdoor waterproof cabinet, the external insulation is free from being eroded and affected by rainwater, and an insulation requirement can be met without increasing a creepage distance of external insulation, so the insulating enclosure 1 can employ an insulating skirt-free structure, and an impulse breakdown voltage of the electrohydraulic air extinguishing chamber can be reduced to zero by using the free telescoping shift assembly 6 (temperature-sensitive spring) to short-circuit the liquid gap. A breakdown voltage and a power frequency withstand voltage of the arc-extinguishing channel are determined by a breakdown voltage of the series external air gaps. Under the condition of a power frequency voltage, the electric field air gap 120 between the discharge electrode plates 14 (graphite sheets) is in an open-circuit state and bears all power frequency voltages, and an electrohydraulic arc-extinguishing chamber in a short-circuit state will not induce a power-frequency short circuit. The whole arc-extinguishing channel is in an open-circuit state. Under the action of a lightning voltage, the electric field air gap 120 between the discharge electrode plates 14 (graphite sheets) is preferentially broken down through insulation cooperation, which plays a role of limiting and transferring lightning charges. In addition, when the impulse current and the power frequency follow current flow through the discharge electrode plate 14 (graphite sheet) and a free telescoping displacement assembly 6 (temperature-sensitive spring) connected to the discharge electrode plate in series, the free telescoping displacement assembly contracts to reduce the pitch. This generates an impulse arc and an electrohydraulic pressure to forcibly extinguish the power frequency follow current, thereby forming voltage limiting, charge transfer, and forced arc extinction effects. Safety accidents of long current duration, insulation combustion caused by high temperature rise, transformer winding distortion caused by a long-term short-circuit current electromotive force, wire melting and long-term power failure caused by the existing surge suppressor are solved.

The foregoing is only the preferred embodiment of the present disclosure, and it should be noted that those of ordinary skill in the art can make several improvements and embellishments without departing from the principle of the present disclosure, and these improvements and embellishments should also be regarded as the scope of protection of the present disclosure.

What is claimed is:

1. An electrohydraulic dynamic shift arc extinguishing structure, wherein the shift arc extinguishing structure comprises an insulating enclosure (1), an air terminal (2), a lower electrode plate (4), and a free telescoping shift assembly (6) vertically arranged in a cavity of the insulating enclosure (1), wherein the cavity of the insulating enclosure (1) is filled with an insulating liquid (7);
the air terminal (2) is vertically arranged at a top end of the insulating enclosure (1), a lower end of the air terminal (2) extends downward into the insulating enclosure (1) and is electrically connected to an upper end of the free telescoping shift assembly (6); the lower electrode plate (4) is horizontally arranged in a bottom end of the insulating enclosure (1), a screw (5) is vertically arranged at the bottom end of the insulating enclosure (1), an upper end of the screw (5) vertically extends upward into a bottom end in the cavity of the insulating enclosure (1) and is connected to a lower surface of the lower electrode plate (4), and a lower end of the free telescoping shift assembly (6) vertically extends downward to a position above the lower electrode plate (4) and is in contact with an upper surface of the lower electrode plate (4), or separated from the upper surface of the lower electrode plate (4) by a gap.

2. The electrohydraulic dynamic shift arc extinguishing structure according to claim 1, wherein an earthing electrode (10) is vertically and fixedly arranged on the upper surface of the lower electrode plate (4), a displacement electrode (11) is arranged at the lower end of the free telescoping shift assembly (6), and a lower end of the displacement electrode (11) at the lower end of the free telescoping shift assembly (6) is in contact with a tip of the earthing electrode (10), or separated from the tip of the earthing electrode (10) by a gap.

3. The electrohydraulic dynamic shift arc extinguishing structure according to claim 2, wherein a shift electrode plate (12) is horizontally arranged at a lower end of the displacement electrode (11), and the center of a surface of the shift electrode plate (12) is in contact with the tip of the earthing electrode (10), or separated from the tip of the earthing electrode (10) by a gap.

4. The electrohydraulic dynamic shift arc extinguishing structure according to claim 1, wherein an upper electrode plate (3) is horizontally and fixedly arranged on an inner top end of the cavity of the insulating enclosure (1), the lower end of the air terminal (2) extends downward into the insulating enclosure (1) and is fixedly connected to an upper surface of the upper electrode plate (3), and a lower surface of the upper electrode plate (3) is electrically connected to the upper end of the free telescoping shift assembly (6).

5. The electrohydraulic dynamic shift arc extinguishing structure according to claim 1, wherein a section of positioning cavity (8) in communication with the air terminal and the cavity of the insulating enclosure is arranged between the lower end of the air terminal (2) and the inner top end of the cavity of the insulating enclosure (1), and a diameter of the positioning cavity (8) is smaller than that of the cavity of the insulating enclosure (1); the upper electrode plate (3) is horizontally and fixedly arranged at a top end of the positioning cavity (8), and the lower end of the air terminal (2) extends downward into the top end of the positioning cavity (1) and is connected to the center of the upper surface of the upper electrode plate (3); the upper end of the free telescoping shift assembly (6) is partially arranged in the positioning cavity (8), and the upper end of the free telescoping shift assembly (6) is connected to the lower surface of the upper electrode plate (3).

6. The electrohydraulic dynamic shift arc extinguishing structure according to claim 5, wherein a partition electrode plate (9) is horizontally and fixedly arranged in the positioning cavity (8) above the inner top end of the cavity of the insulating enclosure (1), and a plurality of layers of discharge electrode plates (14) which are uniformly stacked are arranged in the positioning cavity (8) between the partition electrode plate (9) and the upper electrode plate (3), and the upper end of the free telescoping shift assembly (6) extends into the positioning cavity (8) and is connected to a lower surface of the partition electrode plate (9).

7. The electrohydraulic dynamic shift arc extinguishing structure according to claim 6, wherein a uniform electric field air gap (120) is disposed between adjacent layers of discharge electrode plates (14), the electric field air gap (120) has a height of 0.1 mm to 1 mm, and the discharge electrode plate (14) is a graphite sheet or a metal oxide electrode plate.

8. The electrohydraulic dynamic shift arc extinguishing structure according to claim 1, wherein the free telescoping shift assembly (6) is a temperature-sensitive spring, and an insulating skirt (13) is disposed on an outer wall of the insulating enclosure (1).

9. An arc extinguishing method of the electrohydraulic dynamic shift arc extinguishing structure according to claim 1, comprising the following steps:
before lightning interception, establishing an electric arc extinguishing channel through an air terminal (2), an upper electrode plate (3), a free telescoping shift assembly (6), a lower electrode plate (4) and a screw (5) in a cavity of an insulating enclosure (1), wherein the free telescoping shift assembly (6) is a temperature-sensitive spring;
during lightning interception, enabling an impulse voltage to break through an outer air gap above the air terminal (2), and an impulse current and a power frequency follow current to enter the electric arc extinguishing channel formed by the telescopic shift assembly (6) composed of the temperature-sensitive spring in the insulating enclosure (1) from the air terminal (2), wherein when the current passes through the free telescoping shift assembly (6), a temperature of the temperature-sensitive spring rises, and the impulse current and the power frequency follow current are discharged in an insulating liquid gap to form an initial short arc which is able to trigger an initial electrohydraulic effect and generate an initial electrohydraulic pressure, the initial electrohydraulic pressure drives the free telescoping shift assembly (6) to contract at a high speed to move upwards, which makes an insulating liquid gap between a lower end of the free telescoping shift assembly (6) and the lower electrode plate (4) increase suddenly, thereby elongating a length of a discharge arc instantly, wherein a generated high-intensity electrohydraulic pressure acts on a surface of a long arc to form a full-scale arc break and forcibly extinguish the impulse current and a power frequency follow current.

10. A surge suppressor, comprising the shift arc extinguishing structure according to claim 1, wherein the shift arc extinguishing structure comprises an insulating enclosure (1), an air terminal (2), a lower electrode plate (4), and a free telescoping shift assembly (6) vertically arranged in a cavity of insulating enclosure (1), wherein the cavity of the insulating enclosure (1) is filled with an insulating liquid (7), the air terminal (2) is vertically arranged at a top end of the insulating enclosure (1), an upper electrode plate (3) is horizontally and fixedly arranged at an inner top end of the cavity of the insulating enclosure (1), the lower electrode plate (4) is horizontally arranged in a bottom end of the insulating enclosure (1), a screw (5) is vertically arranged outside the bottom end of the insulating enclosure (1), an upper end of the screw (5) vertically extends into a bottom end in the cavity of the insulating enclosure (1) and is connected to a lower surface of the lower electrode plate (4), a lower end of the free telescoping shift assembly (6) vertically extends downward to a position above the lower electrode plate (4) and is in contact with an upper surface of the lower electrode plate (4), or separated from the upper surface of the lower electrode plate

(4) by a gap, a partition electrode plate (9) is horizontally and fixedly arranged in a positioning cavity (8) above the inner top end of the cavity of the insulating enclosure (1), a plurality of layers of discharge electrode plates (14) which are uniformly stacked are arranged in the positioning cavity (8) between the partition electrode plate (9) and the upper electrode plate (3), and an upper end of the free telescoping shift assembly (6) extends into the positioning cavity (8) and is connected to a lower surface of the partition electrode plate (9).

11. The electrohydraulic dynamic shift arc extinguishing structure according to claim 2, wherein the free telescoping shift assembly (6) is a temperature-sensitive spring, and an insulating skirt (13) is disposed on an outer wall of the insulating enclosure (1).

12. The electrohydraulic dynamic shift arc extinguishing structure according to claim 3, wherein the free telescoping shift assembly (6) is a temperature-sensitive spring, and an insulating skirt (13) is disposed on an outer wall of the insulating enclosure (1).

13. The electrohydraulic dynamic shift arc extinguishing structure according to claim 4, wherein the free telescoping shift assembly (6) is a temperature-sensitive spring, and an insulating skirt (13) is disposed on an outer wall of the insulating enclosure (1).

14. The electrohydraulic dynamic shift arc extinguishing structure according to claim 5, wherein the free telescoping shift assembly (6) is a temperature-sensitive spring, and an insulating skirt (13) is disposed on an outer wall of the insulating enclosure (1).

15. The electrohydraulic dynamic shift arc extinguishing structure according to claim 6, wherein the free telescoping shift assembly (6) is a temperature-sensitive spring, and an insulating skirt (13) is disposed on an outer wall of the insulating enclosure (1).

16. The electrohydraulic dynamic shift arc extinguishing structure according to claim 7, wherein the free telescoping shift assembly (6) is a temperature-sensitive spring, and an insulating skirt (13) is disposed on an outer wall of the insulating enclosure (1).

17. The arc extinguishing method according to claim 9, wherein an earthing electrode (10) is vertically and fixedly arranged on the upper surface of the lower electrode plate (4), a displacement electrode (11) is arranged at the lower end of the free telescoping shift assembly (6), and a lower end of the displacement electrode (11) at the lower end of the free telescoping shift assembly (6) is in contact with a tip of the earthing electrode (10), or separated from the tip of the earthing electrode (10) by a gap.

18. The arc extinguishing method according to claim 17, wherein a shift electrode plate (12) is horizontally arranged at a lower end of the displacement electrode (11), and the center of a surface of the shift electrode plate (12) is in contact with the tip of the earthing electrode (10), or separated from the tip of the earthing electrode (10) by a gap.

19. The arc extinguishing method according to claim 9, wherein an upper electrode plate (3) is horizontally and fixedly arranged on an inner top end of the cavity of the insulating enclosure (1), the lower end of the air terminal (2) extends downward into the insulating enclosure (1) and is fixedly connected to an upper surface of the upper electrode plate (3), and a lower surface of the upper electrode plate (3) is electrically connected to the upper end of the free telescoping shift assembly (6).

20. The arc extinguishing method according to claim 9, wherein a section of positioning cavity (8) in communication with the air terminal and the cavity of the insulating enclosure is arranged between the lower end of the air terminal (2) and the inner top end of the cavity of the insulating enclosure (1), and a diameter of the positioning cavity (8) is smaller than that of the cavity of the insulating enclosure (1); the upper electrode plate (3) is horizontally and fixedly arranged at a top end of the positioning cavity (8), and the lower end of the air terminal (2) extends downward into the top end of the positioning cavity (1) and is connected to the center of the upper surface of the upper electrode plate (3); the upper end of the free telescoping shift assembly (6) is partially arranged in the positioning cavity (8), and the upper end of the free telescoping shift assembly (6) is connected to the lower surface of the upper electrode plate (3).
